(19) United States
(12) Patent Application Publication
(10) Pub. No.: US 2016/0311187 A1
(43) Pub. Date: Oct. 27, 2016

(54) Method of Preparing an Annular Component Useful as an Air Barrier

(71) Applicant: EXXONMOBIL CHEMICAL PATENTS INC., Baytown, TX (US)

(72) Inventors: Porter C. SHANNON, Seabrook, TX (US); Michael J. VINCK, Lebbeke (BE); Peter W. MANDERS, Hudson, OH (US)

(21) Appl. No.: 15/105,222

(22) PCT Filed: Nov. 14, 2014
(86) PCT No.: PCT/US2014/065768

§ 371 Date: Jun. 16, 2016

Related U.S. Application Data
(60) Provisional application No. 61/933,470, filed on Jan. 30, 2014.

(51) Int. Cl. B29D 30/44; B29C 65/00; B29C 47/00; B29C 65/02; B29D 30/06; B29D 30/30

(52) U.S. Cl. CPC B29D 30/44; B29D 30/0681; B29D 30/3007; B29C 47/0059; B29C 47/0004; B29C 47/0021; B29C 65/02; B29C 66/022; B29C 66/0242; B29C 66/1122; B29C 66/73186; B29D 2030/0682; B29D 2030/4437

(57) ABSTRACT

The invention is directed to a method of forming an annular component useful as an air barrier comprising wrapping a sheet around a building drum to create an annular component having overlapping opposing edges thereby forming an overlapping seam, the sheet having a modulus as determined according to ASTM D412-92 greater than about 6.5 MPa, wherein the edges of the seam are modified prior to wrapping.

### PRIORITY

This invention claims priority to and the benefit of U.S. Ser. No. 61/933,470, filed Jan. 30, 2014.

### FIELD OF THE INVENTION

The present invention relates to an annular component useful as an air barrier. More particularly, the present invention is directed to a method of preparing an annular component useful as an air barrier for tire and other industrial rubber applications.

### BACKGROUND OF THE INVENTION

The present invention is related to an annular component particularly useful for tire and other industrial rubber applications that require impermeability characteristics.

Annular components useful as air barriers made from thermoplastic containing materials, such as dynamically vulcanized alloys (DVA), are prepared by extruding blown film tubes, cutting the tubes to size, and inserting the tubes onto a building drum as sleeves. U.S. Pat. No. 5,468,444 discloses standard blown film technology. Incorporating such components in the conventional tire manufacturing process is disadvantageous in that this sleeve method is difficult to implement in an automated manner.

In order to fit an annular component useful as an air barrier in tires and industrial rubber applications using the conventional manufacturing process, a sheet method has been employed in the prior art in which extruded blown film tubes are slit and cut into discreet sheets which are then wrapped around tire building drums with overlapping ends, and the splices are sealed to form seams.

Compared to the sleeve method, the sheet method has the advantage of being easy to incorporate in a conventional tire manufacturing process. However, the sheet method disadvantageously contains an overlapping seam as the film edges are not taper-cut prior to forming the seam. Due to the typical film thickness and limited tacky nature of the film, conventional splicing techniques are not an option. The increased total thickness of the annular component at the seam contributes to unfavorable strain in the region adjacent to the splice. Furthermore, the edges of the seam are uncurable and thereby hinder the annular component layer from chemically crosslinking with other layers in a tire or industrial rubber material, potentially leading to an in-situ crack at the splice. This increased stiffness and uncurability can lead to unsatisfactory tire performance.

JP 2013-010391 discloses an innerliner layer wherein the edge of at least one layer of the overlap is curved with a wire and recesses and projects along the direction of the tire. JP 2012-254718 discloses an innerliner layer containing through-holes along one layer of the overlapping surface. JP 2012-254717 discloses an innerliner layer containing penetrations through the overlap. There are also examples of heat sealing the overlapping seam. For example, see EP2123479.

However, a need still exists for a method of overcoming the relative stiffness of the annular component by reducing the stiffness of the overlap while also eliminating the bare edges of the overlapping layers such that the entire length of the annular component is curable to other layers in a tire or industrial rubber material.

Accordingly, the present invention is directed to a method of preparing an annular component useful as an air barrier in tire and other industrial rubber applications to address both the strain and in-situ cracks associated with tire and industrial rubber manufacturing.

### SUMMARY OF THE INVENTION

The foregoing and/or other challenges are addressed by the products and methods disclosed herein.

In one aspect, the present invention is directed to a method of forming an annular component useful as an air barrier comprising wrapping a sheet around a building drum to create an annular component having overlapping opposing edges thereby forming an overlapping seam, the sheet having a modulus as determined according to ASTM D412-92 greater than about 6.5 MPa, wherein the edges of the seam are modified prior to wrapping.

In one aspect, the present invention is directed to an article comprising an annular component useful as an air barrier, the annular component having a modulus as determined according to ASTM D412-92 greater than about 6.5 MPa, wherein the annular component has an overlapping seam and the gauge of the component at the overlapping seam is equivalent to the average gauge of the component.

In one aspect, the present invention is directed to a method of forming an annular component useful as an air barrier comprising wrapping a sheet around a building drum to create an annular component having overlapping opposing edges thereby forming an overlapping seam, the sheet having a modulus as determined according to ASTM D412-92 greater than about 6.5 MPa, wherein the total thickness of the sheet at the overlapping seam is reduced from greater than or equal to about 2x to about x, where x is an average total thickness of the sheet, and wherein the edges of the seam are modified prior to wrapping.

### BRIEF DESCRIPTION OF THE DRAWINGS

FIG. 1 depicts a blown film tube with selectively reduced thickness.

FIG. 2 depicts a sheet formed by collapsing the blown film tube of FIG. 1 where the sheet is useful as a tire innerliner.

FIG. 3 depicts a sheet having serrated cuts.

FIG. 4 depicts a sheet pressed between two cylinders.

FIG. 5 depicts a sheet severed by tension exerted along the sheet until it breaks.

FIG. 6a depicts a sheet having a series of perforations. FIG. 6b depicts the sheet of FIG. 6a severed in a manner as illustrated in FIG. 5.

FIG. 7 depicts a sheet having a series of fibrils.

FIG. 8 depicts a seam formed by folding and tucking the edges of a sheet.

FIG. 9 depicts a seam formed by abutting the edges of a sheet.

FIG. 10 depicts a sheet formed by the cast film process.

FIG. 11 depicts a DVA prepared by the sheet method.

### DETAILED DESCRIPTION OF THE INVENTION

Various specific embodiments of the invention will now be described, including preferred embodiments and definitions that are adopted herein for purposes of understanding the claimed invention. While the illustrative embodiments have been described with particularity, it will be understood that various other modifications will be apparent to and can be readily made by those skilled in the art without departing from the spirit and scope of the invention. For determining infringement, the scope of the “invention” will refer to any one or more of the appended claims, including their equivalents and elements or limitations that are equivalent to those that are recited.

This invention relates to a method of forming an annular component useful as an air barrier comprising wrapping a sheet around a building drum to create an annular component having overlapping opposing edges thereby forming an overlapping seam, the sheet having a modulus as determined according to ASTM D412-92 greater than about 6.5 MPa, wherein the edges of the seam are modified prior to wrapping.

### Definitions

Definitions applicable to the presently described invention are as described below.

Gauge generally refers to the thickness of a single layer of a sheet. Generally, the gauge of a DVA film ranges from about 50 to about 200 micrometers. Generally, the gauge of the overlapping seam of an innerliner ranges from about 1 to about 20 millimeters. Gauge is measured according to ASTM D4805. The average gauge is measured according to ASTM D6988-13.

Total thickness generally refers to the sum total of the gauge of each layer of a sheet making up an annular component. For example, the total thickness of a two layer sheet is 2x, where x is the gauge of each layer of the sheet.

Modulus generally refers to the tendency of a film or sheet to be deformed upon the application of a force. M50 is used herein to refer to 50% modulus measured according to ASTM D412-92. Higher M50 values generally correlate with favorably high impermeability. Generally, the M50 of DVA ranges from about 6.5 to about 25 MPa. Preferably, the M50 of DVA is within a range of about 6.8 MPa or 7 MPa or 7.2 MPa or 11 MPa or 15 MPa to less than about 18 MPa or 20 MPa or 25 MPa.

Tubular film refers to a film that can be produced from any blown film process known in the art. A non-limiting example of a blown film process includes one employing a cylinder of film that can be collapsed upon itself.

Sheet or sheet film refers to a single layer of a film that is generally wound onto a roll. Non-limiting examples of sheet film include cast film, blown film slit along an edge that is opened and potentially rolled into a single film with a layflat twice that of the original film, blown films slit along two edges and forming two separate sheets of film, and calendared sheet.

Stiff material refers to a material that has 1.5 times the stiffness of the least stiff cured layer when assembled in a tire. Stiffness per unit width of a layer can be calculated as the modulus (such as M50) times the gauge of a layer. Stiffness per unit width is measured in N/m.

Polymer refers to homopolymers, copolymers, interpolymers, terpolymers, etc. Likewise, a copolymer may refer to a polymer comprising at least two monomers, optionally with other monomers. When a polymer is referred to as comprising a monomer, the monomer is present in the polymer in the polymerized form of the monomer or in the polymerized form of a derivative from the monomer (i.e., a monomeric unit). However, for ease of reference, the phrase comprising the (respective) monomer or the like, is used as shorthand.

Elastomer(s) refers to any polymer or composition of polymers consistent with the ASTM D1566 definition of “a material that is capable of recovering from large deformations, and can be, or already is, modified to a state in which it is essentially insoluble, if vulcanized, (but can swell) in a solvent.” Elastomers are often also referred to as rubbers. The term elastomer may be used herein interchangeably with the term rubber. Preferred elastomers have a melting point that cannot be measured by DSC or if it can be measured by DSC is less than 40° C., or preferably less than 20° C., or less than 0° C. Preferred elastomers have a Tg of −50° C. or less as measured by DSC.

Vulcanized or cured refers to the chemical reaction that forms bonds or crosslinks between the polymer chains of an elastomer.

Dynamic vulcanization refers to a vulcanization process in which a vulcanizable elastomer, present with a thermoplastic resin, is vulcanized under conditions of high shear. As a result of the shear mixing, the vulcanizable elastomer is simultaneously crosslinked and dispersed as fine particles of a “micro gel” within the thermoplastic resin, creating a dynamically vulcanized alloy (“DVA”). DVA generally comprises at least one elastomer comprising C4 to C7 isomonoolefin derived units and at least one thermoplastic resin having a melting temperature in the range of 170° C. to 260° C., wherein the elastomer is present as a dispersed phase of small particle in a continuous phase of the thermoplastic resin. The unique characteristic of the DVA is that, notwithstanding the fact that the elastomer component may be fully cured; the DVA can be processed and reprocessed by conventional rubber processing techniques, such as extrusion, injection molding, compression molding, etc. Scrap or flashing can be salvaged and reprocessed.

### Elastomer

The elastomeric component of the DVA may be selected from an assortment of thermosetting, elastomeric materials. For uses where impermeability of the final article to be produced is desired, the use of at least one low-permeability elastomer is desired.

Useful for this invention are elastomers derived from a mixture of monomers, the mixture having at least the following monomers: a C₄ to C₇ isoolefin monomer and a polymerizable monomer. In such mixtures, the isoolefin is present in a range from 70 to 99.5 wt % of the total monomers in any embodiment, or 85 to 99.5 wt % in any embodiment. The polymerizable monomer is present in amounts in the range of from 30 to about 0.5 wt % in any embodiment, or from 15 to 0.5 wt % in any embodiment, or from 8 to 0.5 wt % in any embodiment. The elastomer will contain monomer derived unit amounts having the same weight percentages.

The isoolefin is a C₄ to C₇ compound, non-limiting examples of which are compounds such as isobutylene, isobutene, 2-methyl-1-butene, 3-methyl-1-butene, 2-methyl-2-butene, 1-butene, 2-butene, methyl vinyl ether, indene, vinyltrimethylsilane, hexene, and 4-methyl-1-pentene. The polymerizable monomer may be a C₄ to C₁₄ multiolefin such as isoprene, butadiene, 2,3-dimethyl-1,3-butadiene, myrcene, 6,6-dimethyl-fulvene, hexadiene, cyclopentadiene, and piperylene. Other polymerizable monomers such as styrene, alkylstyrene, e.g., p-methylstyrene, and dichlorostyrene are also suitable for preparing a useful elastomer.

Preferred elastomers useful in the practice of this invention include isobutylene-based elastomers. An isobutylene based elastomer or a polymer refers to an elastomer or a polymer comprising at least 70 mol % repeat units from isobutylene and at least one other polymerizable unit. The isobutylene-based copolymer may or may not be halogenated.

In any embodiment of the invention, the elastomer may be a butyl-type rubber or branched butyl-type rubber, especially halogenated versions of these elastomers. Useful elastomers are unsaturated butyl rubbers such as copolymers of olefins or isoolefins and multiolefins. Non-limiting examples of unsaturated elastomers useful in the method and composition of the present invention are poly(isobutylene-co-isoprene), polyisoprene, polybutadiene, polyisobutylene, poly(styrene-co-butadiene), natural rubber, star-branched butyl rubber, and mixtures thereof. Useful elastomers in the present invention can be made by any suitable means known in the art, and the invention is not herein limited by the method of producing the elastomer. Butyl rubber is obtained by reacting isobutylene with 0.5 to 8 wt % isoprene, or reacting isobutylene with 0.5 wt % to 5.0 wt % isoprene—the remaining weight percent of the polymer being derived from isobutylene; the butyl rubber contains monomer derived unit amounts having the same weight percentages.

Elastomeric compositions of the present invention may also comprise at least one random copolymer comprising a C₄ to C₇ isoolefin and an alkylstyrene comonomer. The isoolefin may be selected from any of the above listed C₄ to C₇ isoolefin monomers, and is preferably an isomonoolefin, and in any embodiment may be isobutylene. The alkylstyrene may be para-methylstyrene, containing at least 80%, more alternatively at least 90% by weight of the para-isomer. The random copolymer may optionally include functionalized interpolymers. The functionalized interpolymers have at least one or more of the alkyl substituents groups present in the styrene monomer units; the substituent group may be a benzylic halogen or some other functional group. In any embodiment, the polymer may be a random elastomeric copolymer of a C₄ to C₇ α-olefin and an alkylstyrene comonomer. The alkylstyrene comonomer may be para-methylstyrene containing at least 80%, alternatively at least 90% by weight, of the para-isomer. The random comonomer may optionally include functionalized interpolymers wherein at least one or more of the alkyl substituents groups present in the styrene monomer units contain a halogen or some other functional group; up to 60 mol % of the para-substituted styrene present in the random polymer structure may be functionalized. Alternatively, in any embodiment, from 0.1 to 5 mol % or 0.2 to 3 mol % of the para-substituted styrene present may be functionalized.

The functional group may be halogen or some other functional group which may be incorporated by nucleophilic substitution of any benzylic halogen with other groups such as carboxylic acids; carboxy salts; carboxy esters, amides and imides; hydroxy; alkoxide; phenoxide; thiolate; thioether; xanthate; cyanide; cyanate; amino and mixtures thereof. In any embodiment, the elastomer comprises random polymers of isobutylene and 0.5 to 20 mol % para-methylstyrene wherein up to 60 mol % of the methyl substituent groups present on the benzyl ring is functionalized with a halogen, such as bromine or chlorine, an acid, or an ester.

In any embodiment, the functionality on the elastomer is selected such that it can react or form polar bonds with functional groups present in the thermoplastic resin, for example, acid, amino or hydroxyl functional groups, when the DVA components are mixed at reactive temperatures.

Other suitable low-permeability elastomers are isobutylene containing elastomers, such as isobutylene-isoprene-alkylstyrene terpolymers or halogenated isobutylene-isoprene-alkylstyrene terpolymers wherein for each of these terpolymers, the isobutylene derived component in the terpolymer is 70 to 99 wt % of the monomer units in the polymer, the isoprene derived component is 29 to 0.5 wt % of the monomer units in the polymer, and the alkylstyrene derived component is 29 to 0.5 wt % of the monomer units in the polymer.

Suitable C₄ to C₇ isoolefin derived elastomers (including the brominated isobutylene-paramethylstyrene copolymers) have a number average molecular weight Mn of at least about 25,000, preferably at least about 50,000, preferably at least about 75,000, preferably at least about 100,000, preferably at least about 150,000. The polymers may also have a ratio of weight average molecular weight (Mw) to number average molecular weight (Mn), i.e., Mw/Mn of less than about 6, preferably less than about 4, more preferably less than about 2.5, most preferably less than about 2.0. In another embodiment, suitable halogenated isobutylene elastomer components include copolymers (such as brominated isobutylene-paramethylstyrene copolymers) having a Mooney viscosity (1+4) at 125° C. (as measured by ASTM D 1646-99) of 30 or more, or more preferably 40 or more.

Preferred elastomers include copolymers of isobutylene and para-alkylstyrene, which may or may not be halogenated. Preferably the copolymer of isobutylene and para-alkylstyrene is halogenated. Such elastomers are described in European Patent Application No. 0344021. The copolymers preferably have a substantially homogeneous compositional distribution. Preferred alkyl groups for the para-alkylstyrene moiety include alkyl groups having from 1 to 5 carbon atoms, primary haloalkyl, secondary haloalkyl having from 1 to 5 carbon atoms and mixtures thereof. A preferred copolymer comprises isobutylene and para-methylstyrene. Preferred brominated copolymers of isobutylene and para-methylstyrene include those having 5 to 12 wt % para-methylstyrene, 0.3 to 1.8 mol % brominated para-methylstyrene, and a Mooney viscosity of 30 to 65 (1+4) at 125° C. (as measured by ASTM D 1646-99).

### Thermoplastic Resin

For purposes of the present invention, a thermoplastic (alternatively referred to as thermoplastic resin) is a thermoplastic polymer, copolymer, or mixture thereof having a Young's modulus of more than 200 MPa at 23° C. The resin should have a melting temperature of about 160° C. to about 260° C., preferably less than 260° C., and most preferably less than about 240° C. In a preferred embodiment, the thermoplastic resin should have a molecular weight in the range of 13,000 to 50,000. By conventional definition, a thermoplastic is a synthetic resin that softens when heat is applied and regains its original properties upon cooling.

Such thermoplastic resins may be used singly or in combination and generally contain nitrogen, oxygen, halogen, sulfur or other groups capable of interacting with an aromatic functional groups, such as halogen of acidic groups. Suitable thermoplastic resins include resins selected from the group consisting of polyamides, polyimides, polycarbonates, polyesters, polysulfones, polylactones, polyacetals, acrylonitrile-butadiene-styrene resins (ABS), polyphenyleneoxide (PPO), polyphenylene sulfide (PPS), polystyrene, styrene-acrylonitrile resins (SAN), styrene maleic anhydride resins (SMA), aromatic polyketones (PEEK, PED, and PEKK), ethylene copolymer resins (EVA or EVOH) and mixtures thereof.

Suitable polyamides (nylons) comprise crystalline or resinous, high molecular weight solid polymers including homopolymers, copolymers, and terpolymers having recurring amide units within the polymer chain. Polyamides may be prepared by polymerization of one or more epsilon lactams such as caprolactam, pyrrolidione, lauryllactam and aminoundecanoic lactam, or amino acid, or by condensation of dibasic acids and diamines. Both fiber-forming and molding grade nylons are suitable. Examples of polyamides include polycaprolactam (nylon-6), polylauryllactam (nylon-12), polyhexamethyleneadipamide (nylon-6,6) polyhexamethyleneazelamide (nylon-6,9), polyhexamethylenesebacamide (nylon-6,10), polyhexamethylene dodecanediamide (nylon-6,12), polyhexamethyleneisophthalamide (nylon-6, IP) and the condensation product of 11-amino-undecanoic acid (nylon-11). Commercially available polyamides may be advantageously used in the practice of this invention, with linear crystalline polyamides having a softening point or melting point between 160 and 260° C. being preferred.

Suitable polyesters which may be employed include the polymer reaction products of one or a mixture of aliphatic or aromatic polycarboxylic acids esters of anhydrides and one or a mixture of diols. Examples of satisfactory polyesters include poly(trans-1,4-cyclohexylene C₂₋₆ alkane dicarboxylates) such as poly(trans-1,4-cyclohexylene succinate) and poly(trans-1,4-cyclohexylene adipate); poly(cis or trans-1,4-cyclohexanedimethylene) alkanedicarboxylates) such as poly(cis-1,4-cyclohexanedimethylene) oxlate and poly(cis-1,4-cyclohexanedimethylene) succinate, poly(C₂₋₄ alkylene terephthalates) such as poly ethyleneterephthalate and polytetramethylene-terephthalate, poly(C₂₋₄alkylene isophthalates) such as polyethyleneisophthalate and polytetramethylene-isophthalate and like materials. Preferred polyesters are derived from aromatic dicarboxylic acids such as naphthalenic or phthalic acids and C₂ to C₄ diols, such as polyethylene terephthalate and polybutylene terephthalate. Preferred polyesters will have a melting point in the range of 160° C. to 260° C.

Poly(phenylene ether) (PPE) resins which may be used in accordance with this invention are well known, commercially available materials produced by the oxidative coupling polymerization of alkyl substituted phenols. They are generally linear, amorphous polymers having a glass transition temperature in the range of 190° C. to 235° C.

Ethylene copolymer resins useful in the invention include copolymers of ethylene with unsaturated esters of lower carboxylic acids as well as the carboxylic acids per se. In particular, copolymers of ethylene with vinylacetate or alkyl acrylates, for example methyl acrylate and ethyl acrylate can be employed. These ethylene copolymers typically comprise about 60 to about 99 wt % ethylene, preferably about 70 to 95 wt % ethylene, more preferably about 75 to about 90 wt % ethylene. The expression “ethylene copolymer resin” as used herein means, generally, copolymers of ethylene with unsaturated esters of lower (C₁-C₄) monocarboxylic acids and the acids themselves; e.g., acrylic acid, vinyl esters or alkyl acrylates. It is also meant to include both “EVA” and “EVOH”, which refer to ethylene-vinylacetate copolymers, and their hydrolyzed counterpart ethylene-vinyl alcohols.

In the dynamically vulcanized alloy, the thermoplastic resin is present in an amount ranging from about 10 to 98 wt % based on the alloy blend, and from about 20 to 95 wt % in another embodiment. In yet another embodiment, the thermoplastic resin is present in an amount ranging from 35 to 90 wt %. The amount of elastomer in the DVA is in an amount ranging from about 2 to 90 wt % based on the alloy blend, and from about 5 to 80 wt % in another embodiment. In any embodiment of the invention, the elastomer is present in an amount ranging from 10 to 65 wt %. In the invention, the thermoplastic resin is present in the alloy, relative to the amount of elastomer, in an amount in the range of 40 to 80 phr.

### Secondary Elastomer

In some embodiments, the DVA may further comprise a secondary elastomer. The secondary elastomer may be any elastomer, but preferably the secondary elastomer is not an isobutylene-containing elastomer. An example of a preferred secondary elastomer is a maleic anhydride-modified copolymer. Preferably, the secondary elastomer is a copolymer comprising maleic anhydride and ester functionalities such as maleic anhydride-modified ethylene-ethyl acrylate.

The secondary elastomer may be added to the DVA processing extruder simultaneously with the initial elastomer and the thermoplastic resin initial feedstreams. Alternatively, it may be added to the extruder downstream from the elastomer and initial thermoplastic resin feedstreams.

The amount of the secondary elastomer in the DVA may be in the range of from about 2 wt % to about 45 wt %. If the DVA comprises at least one elastomer and a secondary elastomer, the total amount of both the elastomer and secondary elastomer is preferably in the range of from about 2 wt % to about 90 wt %.

This secondary elastomer may be cured along with the primary isoolefin based elastomer or it may be selected to remain uncured and act as a compatibilizer as discussed below.

### Other DVA Components

Other materials may be blended into the DVA to assist with preparation of the DVA or to provide desired physical properties to the DVA. Such additional materials include, but are not limited to, curatives, stabilizers, compatibilizers, reactive plasticizers, non-reactive plasticizers, extenders and polyamide oligomers or low molecular weight polyamide as described in U.S. Pat. No. 8,021,730 B2.

Curing of the primary elastomer is generally accomplished by the incorporation of the curing agents and optionally accelerators, with the overall mixture of any such components referred to as the cure system or cure package. Suitable curing components include sulfur, metal oxides, organometallic compounds, radical initiators. Common curatives include ZnO, CaO, MgO, Al₂O₃, CrO₃, FeO, Fe₂O₃, and NiO. These metal oxides can be used alone or in conjunction with metal stearate complexes (e.g., the stearate salts of Zn, Ca, Mg, and Al), or with stearic acid or other organic acids and either a sulfur compound or an alkyl or aryl peroxide compound or diazo free radical initiators. If peroxides are used, peroxide co-agent commonly used in the art may be employed. The use of peroxide curative may be avoided if the thermoplastic resin is one such that the presence of peroxide would cause the thermoplastic resin to crosslink.

As noted, accelerants (also known as accelerators) may be added with the curative to form a cure package. Suitable curative accelerators include amines, guanidines, thioureas, thiazoles, thiurams, sulfenamides, sulfenimides, thiocarbamates, xanthates, and the like. Numerous accelerators are known in the art and include, but are not limited to, the following: stearic acid, diphenyl guanidine (DPG), tetramethylthiuram disulfide (TMTD), 4,4′-dithiodimorpholine (DTDM), tetrabutylthiuram disulfide (TBTD), 2,2′-benzothiazyl disulfide (MBTS), hexamethylene-1,6-bisthiosulfate disodium salt dihydrate, 2-(morpholinothio) benzothiazole (MBS or MOR), compositions of 90% MOR and 10% MBTS (MOR90), N-tertiarybutyl-2-benzothiazole sulfenamide (TBBS), N-(1,3-dimethylbutyl)-N′-phenyl-p-phenylenediamine (6PPD), and N-oxydiethylene thiocarbamyl-N-oxydiethylene sulfonamide (OTOS), zinc 2-ethyl hexanoate (ZEH), N,N′-diethyl thiourea.

In any embodiment of the invention, at least one curing agent is typically present at about 0.1 to about 15 phr; alternatively at about 1.0 to about 10 phr, or at about 1.0 to 6.0 phr, or at about 1.0 to 4.0 phr, or at about 1.0 to 3.0 phr, or at about 1.0 to 2.5 phr, or at about 2.0 to 5.0 phr. If only a single curing agent is used, it is preferably a metal oxide such as zinc oxide.

Components can be added to compatibilize the viscosity between the elastomer and thermoplastic components include low molecular weight polyamides, maleic anhydride grafted polymers having a molecular weight on the order of 10,000 or greater, methacrylate copolymers, tertiary amines and secondary diamines. One common group of compatibilizers are maleic anhydride-grafted ethylene-ethyl acrylate copolymers (a solid rubbery material available from Mitsui-DuPont as AR-201 having a melt flow rate of 7 g/10 min measured per JIS K6710), as well as butylbenzylsulfonamide and polyisobutylene succinic anhydride. These compounds may act to increase the ‘effective’ amount of thermoplastic material in the elastomeric/thermoplastic compound. The amount of additive is selected to achieve the desired viscosity comparison without negatively affecting the characteristics of the DVA. If too much additive is present, impermeability may be decreased and the excess may have to be removed during post-processing. If not enough compatibilizer is present, the elastomer may not invert phases to become the dispersed phase in the thermoplastic resin matrix.

Both reactive and non-reactive plasticizers can function as compatibilizers due to the nature of a plasticizer. Plasticizers for thermoplastics are generally defined as a compound added to polymeric materials to improve flexibility, extensibility, and processability. Known and conventional thermoplastic plasticizers are supplied in the form of low to high viscosity liquid and may be functionalized. Many different plasticizers are known in the thermoplastic resin art as plasticizers having different compatibilities with each type of thermoplastic resin and having different effects on the properties of the thermoplastic resin. Known thermoplastic plasticizers include different types of esters, hydrocarbons (aliphatic, naphthenic, and aromatic), polyesters, and polycondensates; see Handbook of Thermoplastic Elastomers, Jiri George Drobny, p. 23 (William Andrew Publishing, 2007). For polyamides, known non-reactive plasticizers include hydrocarbons functionalized by tertiary amines, secondary diamines, or sulfonamides.

### Method of Preparing DVA

For thin films, of the type to be used for preparing tire innerliners, the morphology of the DVA is important in obtaining the desired properties. The morphology of the DVA is dependent upon the mixing conditions, including temperature, order of introducing ingredients, residence time, as well as shear rates.

A twin screw extruder is the preferred melt processing device. The extruder preferably has at least two intermeshing and co-rotating screws located along the length of the extruder. At one end of the extruder is a feed throat into which flows at least one feedstream: a primary thermoplastic resin feedstream and/or an elastomer feedstream. The resin or the elastomer in this feedstream may or may not have been prepared as a masterbatch prior to entry into the extruder. Along the length of the extruder, other components are fed into the system.

The DVA may be prepared with an extruder that has more than two screws, and may also be practiced on a ring screw extruder of the type disclosed in U.S. Pat. No. 7,655,728.

After the DVA has been mixed to form the alloy, the DVA exits the extruder and passes through a melt gear pump in preparation for sending the DVA through downstream operations.

The DVA has a stiffness per unit width greater than about 340 N/m. Preferably, the DVA has a stiffness per unit width greater than about 580 N/m. Preferably, the DVA has a stiffness per unit width greater than about 1360 N/m. More preferably, the DVA has a stiffness per unit width greater than about 2320 N/m.

The DVA has a Shore A Hardness greater than 70 as determined according to ASTM D2240. Preferably, the DVA has a Shore A Hardness, as determined according to ASTM D2240, of greater than 75. Preferably, the DVA has a Shore A Hardness, as determined according to ASTM D2240, of greater than 80. More preferably, the DVA has a Shore A Hardness, as determined according to ASTM D2240, of greater than 85.

While reference is made to DVA, one of ordinary skill in the art will appreciate that other materials of high stiffness, such as thermoplastic elastomers, thermoplastic vulcanizates, and thermoplastic films can be used advantageously in the disclosed inventive seaming techniques. Non-limiting examples of other materials that can be used include those disclosed in EP2610072, WO2013/093608, U.S. Pat. No. 8,188,187, and EP2574635.

Preparing an Annular Component having Uniform Total Thickness at the Overlapping Seam

As previously described, the sheet method is often used to fit an annular component useful as an air barrier in tires and industrial rubber applications. In such a method, extruded blown film tubes are slit and cut into discreet sheets which are then wrapped around tire building drums with overlapping ends, and the splices are sealed to form seams. For the purpose of this application, this method of inserting a DVA blown film shall be the referenced “conventional method.” A disadvantage with the above sheet method is that the increased thickness of the annular component at the seam contributes to unfavorable strain in the region adjacent to the splice.

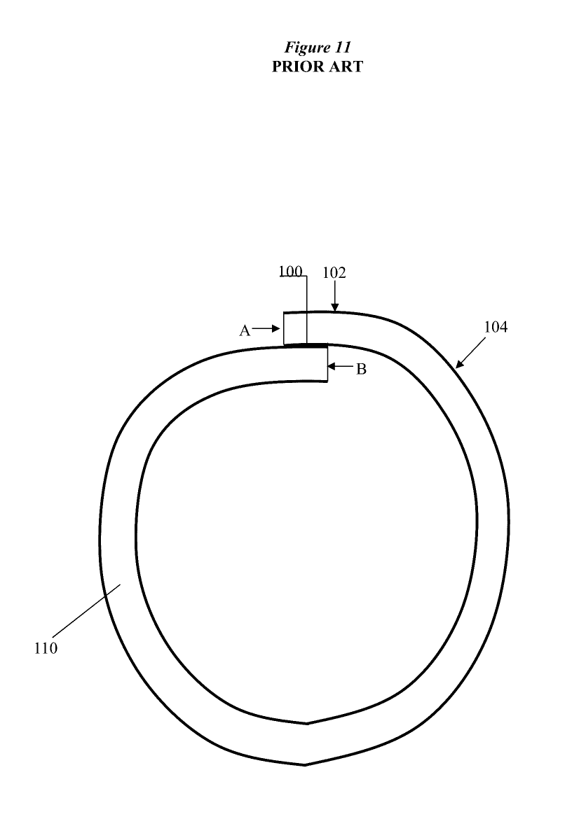

FIG. 11 depicts a DVA prepared by the above method, resulting in an innerliner, 110, with an overlapped seam, 100. During formation of a tire and flexing of a cured, rotating tire, the innerliner is strained. In the region of the overlap, 100, the strain is dispersed over the two overlapping layers, but the strain is actually concentrated at point 102 where there is less material to absorb the strain. The further away from strain location 102, such as point 104, the strain of the material is reduced. When the innerliner is formed of a stiff material and when the subjected strain due to repetitive flexing is greater than the recovery ability of the material, the material is subject to permanent deformation, thereby creating an area for potential failure. In addition, the overlapped ends of the DVA innerliner, A and B, are not rubber curable and thereby hinder the annular component layer from chemically crosslinking with other layers in the tire (or industrial rubber material when used in other articles), potentially leading to an in-situ crack at the splice.

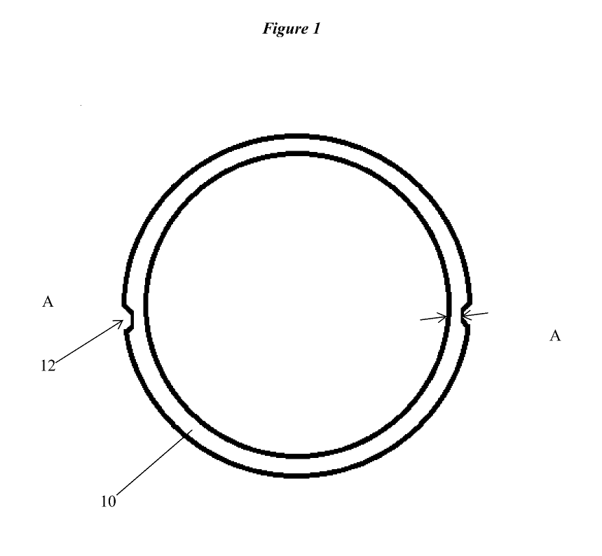

FIG. 1 depicts a blown film tube, 10, in which the gauge of the film 10 in locations, 12, which will form the overlapping seam of an innerliner, is reduced. The film gauge at these locations, 12, may be reduced by using a blown molding apparatus known in the art containing one or more notches. When the tube of average gauge, 0.5×, is blown using the apparatus, one or more notches creates a reduced gauge, y, in the resulting blown film at the region of the notch. The reduced gauge, y, formed in the blown film has a value of 0.4-0.6 of the average gauge 0.5×.

In one embodiment, the blown film may be heated to melt and then pressure sealed to reduce the total thickness of the overlapping seam. After obtaining a blown film tube as illustrated in FIG. 1, the tube 10 may be flattened to form a single layer. The film 10 may be flattened symmetrically such that the centerpoint of the non-seam sections are directly opposed to one another. This has the effect that the width of each doubled over seam section is half of the original width as the layflat fold runs through the center of the seam section.

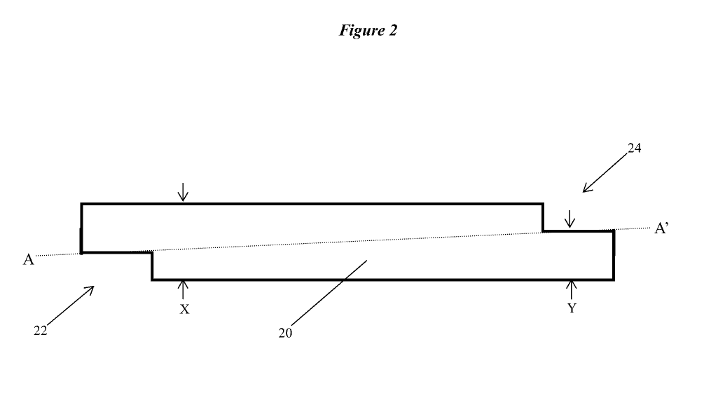

In one embodiment, the film 10 may be flattened asymmetrically as illustrated in FIG. 2. FIG. 2 depicts a sheet 20 formed by collapsing the blown film tube of FIG. 1, at the fold line A-A′ of FIG. 1, where the sheet is useful as a tire innerliner. By collapsing the blown film at line A-A′, and then employing the sheet method to prepare the annular component as described above, the edges 22 and 24 of the sheet 20 having reduced total thickness y. The overlapping seam formed by the edges 22 and 24 will have a uniform total thickness consistent with the total thickness, x, of the other sections of the annular component.

In both embodiments—flattening symmetrically or asymmetrically, the folded seam section will be on the edge of the film layflat. In the case of a single layer film, the film can then be heated above its melt point and sealed through any method known in the art to generate pressure. In the case of a multilayer film, because the innermost layer has a melting point lower than any of the layer of the film and does not act as the air barrier layer, the innermost layer would melt and seal, while the remaining layers would remain non-molten. Therefore, for a multilayer film, an innermost layer may be used that is chemically reactive in response to a stimulus such as UV for curing to itself.

### Modifying the Edges of the Component Prior to Forming the Seam

As described above, the conventional sheet method has increased total thickness at the seam, which contributes to unfavorable strain in the region adjacent to the splice. In addition or in alternative to the above described method, after cutting the blown film tube 10 into a discreet sheet 20 via the sheet method, the edges 22 and 24 of the sheet can be modified to reduce the otherwise high stress concentration that would be present when the edges 22 and 24 form the overlapping seam. Various non-limiting methods that can be used to modify the edges of the component are disclosed herein.

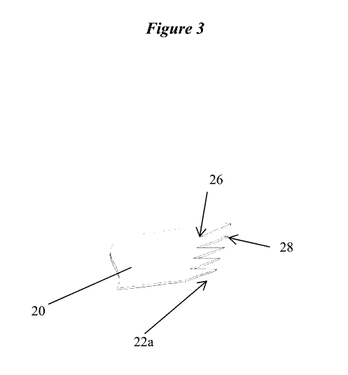

FIG. 3 depicts a sheet 20 having serrated cuts at the edge 22a. In one embodiment, serrated cuts can be created along the sheet edge 22a by shearing the material between two blades that have interlocking v-shaped profiles. If such blades are part of hand-operated shears, the blades pivot about an axis that is perpendicular to the direction of the cut, and the teeth on the blades must be shaped to allow such motion. However, for cutting DVA film in an automated operation, it would be preferable to employ blades that are at least the length of the cut, and to move one or both of them on a linear trajectory perpendicular to the plane of the film as in a guillotine or power shear. Alternatively, a rotary cutter with a zigzag blade could be used. The average stiffness of sheet edge 22a is a function of the location of the cut sheet, wherein the average stiffness of the sheet edge 22a is greater at the location of the bottom of the serrated cuts 26 as compared to the tip of the cuts 28.

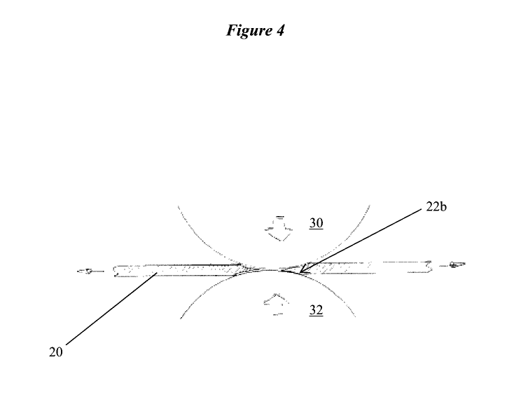

FIG. 4 depicts a sheet 20 pressed between two cylinders 30 and 32. While FIG. 4 depicts cylinders, any apparatus known in the art can be used to press the sheet 20, such as two plates or one cylinder and one plate. In one embodiment, a thinned edge 22b to the DVA sheet 20 could be created by pressing the sheet 20 between two heated cylinders 30 and 32 whose axes are aligned with the direction of the cut, such that the sheet edge 22b is melted and squeezed out as the gap between the cylinders closes, thereby forming a thinned edge 22b. Alternatively, a single cylinder, or plate with a more or less pointed profile, could be pressed against the sheet 20 as it is supported on a plate, and a non-stick release coating or film could be used on one or both tools to prevent the molten sheet edge 22b from sticking. A suitable release film used in commercial plastic film sealing machines is woven glass fiber fabric impregnated with polytetrafluoroethylene.

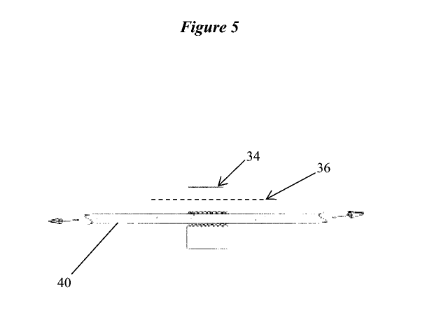

FIG. 5 depicts a sheet 40 that is severed by tension exerted along the component until it breaks. The thinning and cutting can take place simultaneously across the sheet 40, but a preferred method uses a traversing profiled roller or rollers 34 in place of one or both of the cylinders or plates as is illustrated in FIG. 4. In such an implementation, the roller 34 would move across the sheet making the cut, with the roller axis 36 parallel to the sheet and pulling direction of the sheet 40. This would have the advantage of requiring less force to be applied normal to the sheet 40, however the cut would take longer to make. In the case of a heated roller, the bearing would have to operate at elevated temperature or some means provided for keeping the bearing cool.

Rather than relying on pressure between tools to create the thinning and ultimately separation of the sheet 40, tension could be applied to either side of a narrow section heated close to or somewhat above its melting point causing it to neck down and ultimately separate leaving thinned edges. The narrow strip could be heated by conduction from contact with a hot surface, suitably treated or protected to prevent sticking; by convection such as by impingement of hot gas from a slit or series of holes; by radiation such as from proximity to a hot radiating surface or by a directed beam of energy such as from a laser; or by dielectric heating in a narrow zone of alternating electric field. These forms of heating could be applied simultaneously across the sheet 40, or locally, with the sheet 40 being separated in a progressive or tearing motion.

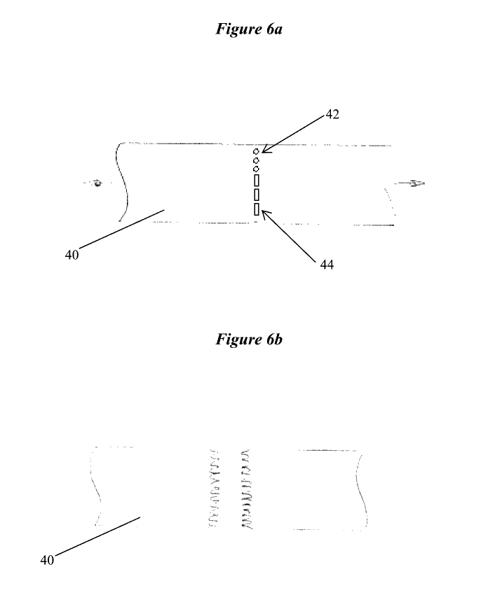

The embodiments described above, of bringing the overlapping edges 22 and 24 to a series of tapered points and/or tapering the thickness of the sheet at the edges, could be combined in an operation that would draw the sheet edges 22 and 24 of FIG. 2 down into a series of elongated tapered points, either below or above the melting point of the film. These methods are useful when the DVA sheet is a continuous sheet, 20 and 40, formed by a collapsed blown film tube or a cast film sheet. The above taper method could be accomplished by perforating the sheet 40 with a series of holes 42 or short slits 44 oriented perpendicular to the direction of the cut, or a combination thereof as illustrated in FIG. 6a. When tension is applied along either side of the line of perforations 42 or 44, the ligaments of film between the perforations are elongated and neck down to the point of failure, as illustrated in FIG. 6b. The sheet 40 is then severed in a manner as illustrated in FIG. 5. Various means could be used to create the line of perforations 42 and 44, such as needles and blades arranged in a straight carrier or a cutter wheel, laser ablation and the like. One or more lines of slits 42 or hole perforations 44 could be used in order to create ligaments that draw down into desirable shapes for reduction of stress in the final tire innerliner. In the case of fluid cutting, an enclosure could be used to develop the pressure, or the fluid could be projected towards the sheet 40 at high velocity such that the hydrodynamic forces are sufficient to rupture the sheet at the perforations 42 and 44. The action of such fluids could be enhanced if solid particles were entrained in the fluid stream as is common in water jet cutting technology.

In addition to creating a separation line, additional spaced perforations may be provided at random or patterned locations to create a means for trapped air to be vented out of a formed article during curing. Due to flow of the DVA during curing, such perforations may be self-healing during curing.

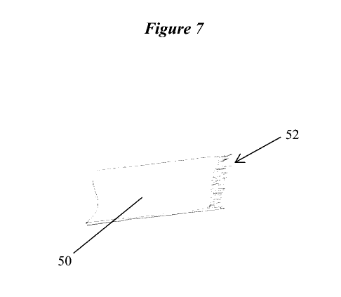

Rather than creating the stress reducing features of the edge of the sheet as an integral result of cutting the sheet, the sheet could first be cut by conventional means and the stress reducing features added as a separate operation. The already cut edge could be thinned to a taper by mechanical abrasion against an abrasive belt or drum. The various means described above could also be applied to the cut edge of a sheet, including heating and pressing to a taper between tools, either simultaneously across the sheet, or progressively through translation of a local operation, tapered or fibrillated by gas or liquid jet such as a water jet. A wire brush wheel could be used to abrade, fibrillate, and stretch and thin the edge while it is supported on a rigid abrasion resistant surface. The process of abrading and fibrillating tapes or yarns is described in INEOS OLEFINS & POLYMERS POLYPROPYLENE PROCESSING GUIDE, p 9. FIG. 7 depicts such a prepared sheet 50 having a series of fibrils 52.

### Improving Bonding of the Annular Component to Other Lavers in a Tire

As previously described, another disadvantage with the conventional sheet method is that the edges of the seam are uncurable and thereby hinder the annular component layer from chemically crosslinking with other layers in the tire or industrial rubber material, potentially leading to an in-situ crack at the splice.

If the blown film of FIG. 1 is a two layer film having an outer layer that is rubber curable, when it is collapsed to form a sheet as in FIG. 2, the entire outer surface of FIG. 2 is also curable. If the blown film of FIG. 1 is extruded with an adhesive outer layer and a rubber curable layer, where the adhesive outer layer is between the DVA sheet and the rubber curable layer, the collapsed sheet as in FIG. 2 would have six layers including an outer rubber curable layer, an adhesive layer, two layers of the sheet, an additional adhesive layer, and an additional outer rubber curable layer.

At least one adhesive system based on epoxidized styrene butadiene styrene block copolymer uses a sulfur curative to diffuse from the adjacent rubber layer into the adhesive layer in order to effect crosslinking of the DVA sheet with the rubber layer which is important for the long term durability and elevated temperature performance of the tire product. Since the DVA sheet is a barrier to this diffusion necessary for the adhesive system, adhesive trapped in the overlapping seam 100 of FIG. 11 will have undesirably low performance. In one embodiment, the various method described above may be used to remove the original adhesive layer and/or create additional new surface area (such as by drawing the film down, fibrillating it, or fracturing) in the area of the overlapping seam 100 of FIG. 11 such that the entire DVA sheet is curable with other layers in the tire or industrial rubber material.

In one embodiment, the adhesive outer layer used to bind the sheet to the adjacent rubber layer can be made up of an adhesive tie gum (ATG) containing ingredients specifically intended to promote adhesion to resorcinol formaldehyde latex (RFL) coated sheet. Examples of RFL adhesive coating and ATG formulation are provided in the prior art. However, these adhesion-promoting ingredients add costs and may not be required in all cases where the annular component is coated with RFL adhesive. In one embodiment, a narrow strip of ATG can be applied in the splice area while the remainder of the compound in contact with the RFL coated liner would be a lower cost formulation. Alternatively, the ingredients that differentiate the ATG from the standard carcass compound, including phenol formaldehyde resin, resorcinol, resorcinol formaldehyde resin, formalin, and hexamethoxymethylmelamine, could be applied to the DVA in the splice area, from where they would diffuse into the surrounding standard carcass compound, effectively converting it into an ATG formulation.

In one embodiment, the multiblown film, after being tapered at the overlap 100 of FIG. 11 is dip coated into a material that both cures to the DVA film layer and to rubber. For example, if the functional material is a nylon based DVA, the dip layer could be any example as described in WO2012/134454.

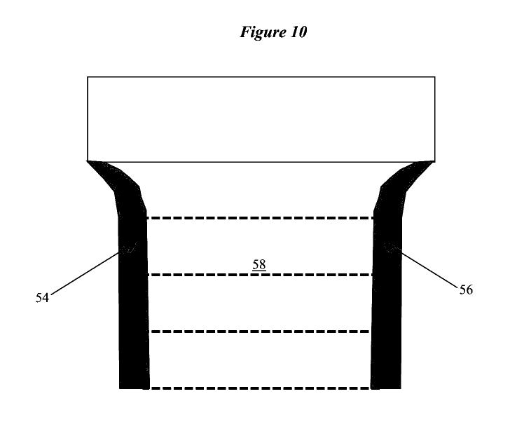

In one embodiment, the DVA film is prepared using a cast film, rather than the blown film depicted in FIG. 1. FIG. 10 depicts the cast film process whereby the dark edges 54 and 56 represent encapsulating dies, such as those available from Cloeren Technology. After the film is prepared using a cast film apparatus known in the art, it is cut in a transverse direction (represented by the dotted lines 58), so that the edges of the extruded to film are rubber curable. The thickness of the film edges can be reduced by any method previously described to reduce the total thickness of the resulting overlap when forming the annular article such as a hose or tire innerliner.

### Method of Forming a Seam

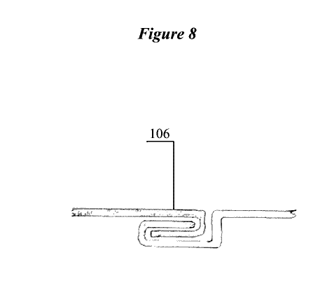

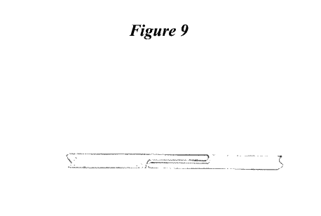

In some prior art, the seam edges A and B which do not have an adhesive coating are buried within other layers of adjacent material, including the sheet itself. FIG. 8 depicts such an embodiment where a seam is formed by folding and tucking the edges of a sheet. Generally, it is favored to minimize the total number of layers in the overlapping seam 106 when wrapping to minimize the overall stress concentration in the tire. However, in the present embodiment, subsequently pressing the seam down to a similar thickness to the annular component itself allows the use multiple layers in the seam. Such a reduction in thickness could be achieved by similar techniques and equipment to that described above for tapering the edge of the sheet. The felled seam can be heated and pressed to diminish its thickness and then cooled. A consequence of such pressing will be to increase the dimensions of the film in the directions perpendicular to the pressing direction, which will lead to a minor increase across the sheet (in the direction of the seam), but a more significant increase in length perpendicular to the seam, i.e., in the circumferential direction of the tire building drum. This may be undesirable because it will cause the sheet to be loose when wrapped around the building drum, resulting in wrinkles when subsequent layers of the tire are wound on top of it. Alternatively, the sheet could be pretensioned as it is placed on the drum by an amount sufficient to take up the slack created by pressing the seam 106 down. Such pre-tensioning of the sheet could have the additional advantage of temporarily creating additional slack to facilitate the folding of the felled seam, and could be held in place by suction from within the building drum, or by mechanically clamping the sheet against the drum. In one embodiment, a seam may be formed by abutting the edges of a sheet as shown in FIG. 9. Prior to forming the seam by either of the methods described herein, the edges of the component may be treated as previously disclosed.

### Specific Embodiments

The invention may also be understood with relation to the following specific embodiments.

Paragraph A: A method of forming an annular component useful as an air barrier comprising wrapping a sheet around a building drum to create an annular component having overlapping opposing edges thereby forming an overlapping seam, the sheet having a modulus as determined according to ASTM D412-92 greater than about 6.5 MPa, wherein the edges of the seam are modified prior to wrapping.

Paragraph B: The method of Paragraph A wherein the sheet is a blown or cast film.

Paragraph C: The method of Paragraph A wherein the edges are modified by creating a series of serrated cuts along the edges.

Paragraph D: The method of Paragraph A wherein the edges are modified by pressing the edges.

Paragraph E: The method of Paragraph D wherein the edges are heated prior to pressing.

Paragraph F: The method of Paragraph A wherein the edges are modified by severing the sheet by exerting tension along the length of the sheet until it breaks.

Paragraph G: The method of Paragraph F wherein a series of perforations are created along the edges prior to severing.

Paragraph H: The method of Paragraph A wherein the edges are modified by creating a series of fibrils along the edges.

Paragraph I: The method of Paragraph A wherein the annular component is a dynamically vulcanized alloy.

Paragraph J: An article comprising an annular component useful as an air barrier, the annular component having a modulus as determined according to ASTM D412-92 greater than about 6.5 MPa, wherein the annular component has an overlapping seam and the gauge of the component at the overlapping seam is equivalent to the average gauge of the component.

Paragraph K: A method of forming an annular component useful as an air barrier comprising wrapping a sheet around a building drum to create an annular component having overlapping opposing edges thereby forming an overlapping seam, the sheet having a modulus as determined according to ASTM D412-92 greater than about 6.5 MPa, wherein the total thickness of the sheet at the overlapping seam is reduced from greater than or equal to about 2x to about x, where x is an average total thickness of the sheet, and wherein the edges of the seam are modified prior to wrapping.

Paragraph L: The method of Paragraph K wherein the edges are modified by creating a series of serrated cuts along the edges.

Paragraph M: The method of Paragraph K wherein the edges are modified by pressing the edges.

Paragraph N: The method of Paragraph M wherein the edges are heated prior to pressing.

Paragraph O: The method of Paragraph K wherein the edges are modified by severing the sheet by exerting tension along the length of the sheet until it breaks.

Paragraph P: The method of Paragraph O wherein a series of perforations are created along the edges prior to severing.

Paragraph Q: The method of Paragraph K wherein the edges are modified by creating a series of fibrils along the edges.

Paragraph R: The method of claim K wherein the annular component is a dynamically vulcanized alloy.

Paragraph S: An article formed of the method of Paragraph K.

Paragraph T: A method of Paragraph K further comprising extruding the component in a blown molding apparatus with an adhesive outer layer and a rubber curable layer, where the adhesive layer is between the component and the rubber curable layer, to form a tubular product; and collapsing the tubular product to form a sheet wherein the sheet contains at least six layers including an outer rubber curable layer, an adhesive layer, two layers of the component, an additional adhesive layer, and an additional outer rubber curable layer.

Paragraph U: The method of Paragraph T wherein the adhesive outer layer is made up of material selected from the group of adhesive tie-gum, resorcinol formaldehyde latex, phenol formaldehyde resin, resorcinol, resorcinol formaldehyde resin, formalin, and hexamethoxymethylmelamine.

Paragraph V: The method of Paragraph K further comprising extruding the component in a cast film apparatus with an adhesive.

Paragraph W: The method of Paragraph V wherein the adhesive is made up of material selected from the group of adhesive tie-gum, resorcinol formaldehyde latex, phenol formaldehyde resin, resorcinol, resorcinol formaldehyde resin, formalin, and hexamethoxymethylmelamine.

All priority documents, patents, publications, and patent applications, test procedures (such as ASTM methods), and other documents cited herein are fully incorporated by reference to the extent such disclosure is not inconsistent with this invention and for all to jurisdictions in which such incorporation is permitted.

When numerical lower limits and numerical upper limits are listed herein, ranges from any lower limit to any upper limit are contemplated.

1. A method of forming an annular component useful as an air barrier comprising wrapping a sheet around a building drum to create an annular component having overlapping opposing edges thereby forming an overlapping seam, the sheet being a blown or cast film of a dynamically vulcanized alloy and having a modulus as determined according to ASTM D412-92 greater than about 6.5 MPa,
wherein the edges of the sheet are modified prior to wrapping.

2. (canceled)

3. The method of claim 1 wherein the edges are modified by creating a series of serrated cuts along the edges.

4. The method of claim 1 wherein the edges are modified by pressing the edges and the edges are heated prior to pressing.

5. (canceled)

6. The method of claim 1 wherein the edges are modified by severing the sheet by exerting tension along the length of the sheet until it breaks.

7. The method of claim 6 wherein a series of perforations are created along the edges prior to severing.

8. The method of claim 1 wherein the edges are modified by creating a series of fibrils along the edges.

9. The method of claim 1 wherein the annular component is a dynamically vulcanized alloy.

10. An article comprising an annular component useful as an air barrier, the annular component having a modulus as determined according to ASTM D412-92 greater than about 6.5 MPa,
wherein the annular component has an overlapping seam and the gauge of the component at the overlapping seam is equivalent to the average gauge of the component.

11. A method of forming an annular component useful as an air barrier comprising wrapping a sheet around a building drum to create an annular component having overlapping opposing edges thereby forming an overlapping seam, the sheet formed from a dynamically vulcanized alloy and having a modulus as determined according to ASTM D412-92 greater than about 6.5 MPa,
wherein the total thickness of the sheet at the overlapping seam is reduced from greater than or equal to about 2x to about x, where x is an average total thickness of the sheet, and wherein the edges of the sheet are modified prior to wrapping.

12. The method of claim 11 wherein the edges are modified by creating a series of serrated cuts along the edges.

13. The method of claim 11 wherein the edges are modified by pressing the edges and the edges are heated prior to pressing.

14. (canceled)

15. The method of claim 11 wherein the edges are modified by severing the sheet by exerting tension along the length of the sheet until it breaks.

16. The method of claim 15 wherein a series of perforations are created along the edges prior to severing.

17. The method of claim 11 wherein the edges are modified by creating a series of fibrils along the edges.

18. (canceled)

19. An article formed of the method of claim 11.

20. A method of claim 11 further comprising:
extruding the component in a blown molding apparatus with an adhesive outer layer and a rubber curable layer, where the adhesive layer is between the component and the rubber curable layer, to form a tubular product; and
collapsing the tubular product to form a sheet wherein the sheet contains at least six layers including an outer rubber curable layer, an adhesive layer, two layers of the component, an additional adhesive layer, and an additional outer rubber curable layer.

21. The method of claim 20 wherein the adhesive outer layer is made up of material selected from the group of adhesive tie-gum, resorcinol formaldehyde latex, phenol formaldehyde resin, resorcinol, resorcinol formaldehyde resin, formalin, and hexamethoxymethylmelamine.

22. The method of claim 11 further comprising extruding the component in a cast film apparatus with an adhesive wherein the adhesive is made up of material selected from the group of adhesive tie-gum, resorcinol formaldehyde latex, phenol formaldehyde resin, resorcinol, resorcinol formaldehyde resin, formalin, and hexamethoxymethylmelamine.

23. (canceled)

24. The method of claim 1 further comprising the sheet being formed by collapsing a tubular blown film wherein the edges of the sheet have been modified by forming the tubular blown film with locations having a reduced gauge relative to the remaining portion of the tube and the tube is collapsed to form a sheet having a reduced total thickness at the edges.

25. The method of claim 8 further comprising the sheet being formed by collapsing a tubular blown film wherein the edges of the sheet have been modified by forming the tubular blown film with locations having a reduced gauge relative to the remaining portion of the tube and the tube is collapsed to form a sheet having a reduced total thickness at the edges.
